(19) United States
(12) Patent Application Publication
(10) Pub. No.: US 2019/0290068 A1
(43) Pub. Date: Sep. 26, 2019

(54) Grilling set made of natural materials

(71) Applicant: Woodbright OÜ, Parnu maakond (EE)

(72) Inventors: Eva LAKS, Pärnu maakond (EE); Riivo KRUUSE, Pärnu maakond (EE)

(73) Assignee: Woodbright OÜ, Parnu maakond (EE)

(21) Appl. No.: 16/173,139

(22) Filed: Oct. 29, 2018

(30) Foreign Application Priority Data
Mar. 23, 2018 (EE) U201800005

(51) Int. Cl. A47J 37/07

(52) U.S. Cl. CPC A47J 37/0768; A47J 36/04; A47J 37/0704

(57) ABSTRACT

The grilling set made of natural material comprises a wooden frame with a cavity cut into it to position the ignition material, wherein ventilation holes are positioned on the sidewalls or the end-walls of the cavity. There are grooves and/or slots on the sides of the surface of the frame for a means for keeping the grilling product above the ignition material, which come in the form of rectangular wooden holders and wooden rods. The ignition material is charcoal briquette burning at a low temperature or thermal-treated wood, and the ignition device is made of natural materials. The wooden holders have slots on at least one of the longer sides, and the holders are mounted into the grooves on the end-walls of the wooden frame horizontally or vertically during use. The wooden rods are mounted into the holes on the end-walls of the cavity of the wooden frame under an about 45° angle or the rods are placed into the slots on the holder to form a grate above the ignition material. To protect the frame from combustion/heat, it may be coated using a natural protective agent.

### PRIORITY

This application claims priority of Estonian Utility Model number U201800005 filed on Mar. 23, 2018, the content of which is incorporated herein by reference.

### FIELD OF THE INVENTION

This invention relates to cooking and grilling devices as well as the field of environmental protection, and in particular, the invention describes a grilling device made of natural materials and its accessories.

### BACKGROUND

The objective of the invention is the development of a grilling device made of natural materials, which would burn up completely and leave no non-degradable residues.

A disposable wooden grilling device (Woodbright OU Eco-Grill), wherein a cavity has been made inside an alder stump that has been filled with grilling charcoal and that is ignited using bark. The grilling device comes with a metal grilling grate. The heating-up process takes about 15-20 minutes, during which time the grilling charcoal achieves its grilling temperature. The grilling process takes about 90 minutes, and this grilling device remains ignited for about 1-2 hours. A shortcoming of this solution is that the grilling temperature is about 800° C., which is too high for cooking meat. Another shortcoming of this solution is the metal grate, due to which the grilling device fails to burn up completely in nature. Also, it fails to provide an evenly distributed combustion, and uniform heat for grilling. Also, the frame of the grill quickly disintegrates in the flames.

Disclosed is also a disposable cooking set (KR10137861261, Hong Gil Mong, published on Mar. 27, 2014), which comprises a disposable cooking device, a metal cooking plate, ignition material, and an ignition device. The ignition device is a solid fuel that has been placed inside a cardboard box covered with an insulating material.

A shortcoming of this solution is the metal grate, which is why the cooking set fails to burn up completely in nature.

Closest prior art to the invention is a cooking device (U.S. Pat. No. 5,535,666, Southerland Glen, published on Jul. 16, 1996) that is meant for grilling. The cooking device includes a frame made of a wooden log with a cavity for fuel. The cavity has a base, two sidewalls, two end-walls. Each end-wall ends with a top edge, into which slots have been made. The device includes a metal grate with an edged frame, where the frame is positioned transversely in relation to the frame, and it has been adapted in such a way that it would match the slots. The cooking device is equipped with a cover made in a similar way as the frame, i.e. it has a cavity on the sidewalls and the end-walls, as well as ventilation slots on the sides of the cover. Foil has been installed at the bottom of the cavity of the cooking device to device the wooden frame from heat/combustion. A shortcoming of this solution is that the device has a metal grate and foil covering the bottom of the cavity, which leave non-degradable residues in the nature. In addition, this cooking device is too big for carrying it along for single-time use.

### SUMMARY OF THE INVENTION

The present grilling set made of natural materials comprises a natural wood frame, one surface of which has been significantly carved out to form a cavity for installing the ignition material, thereat leaving the sides of that surface intact from the cavity. The cavity may have a concave or flat base. The cavities have sidewalls, end-walls and a base, whereat ventilation slots have been placed on the sidewalls and/or end-walls of the cavity. On the sides of the surface, there are grooves and holes for the mounting of the device for holding of the grilling product, wherein the holders of the grilling product over the ignition material are wooden holders and wooden rods.

The wooden holders are rectangular plates with slots along at least one longer side, and holders have been mounted in the grooves on the sides of the surface of the wooden frame in a horizontal or vertical manner. The wooden rods are mounted inside the holes at the sides of the surface of the wooden frame at an about 45-degree angle, or the wooden rods are mounted in the slots of the holder, wherein the holder has been mounted in the grooves in a horizontal or vertical manner.

The ignition material is a charcoal briquette burning at a low temperature and/or thermal-treated wood, and the ignition devices are made of natural materials. In addition, the grilling set may include means for igniting the ignition device.

If necessary, to protect the surface of the wooden frame used for grilling (the cavity and the sides) and/or to slow down the combustion of the frame, they shall be coated with a natural protective agent (clay or salt water).

### BRIEF DESCRIPTION OF THE DRAWINGS

FIG. 1 depicts the grilling set made of natural materials;

FIG. 2 depicts the wooden frame of the grilling set with a circular base of the cavity;

FIG. 3 depicts the wooden frame of the grilling set with a rectangular base of the cavity;

FIG. 4 depicts the rods being placed in the slots for the wooden holders transversely in relation to the holder, where the holder has been positioned horizontally in the slots using its longer side;

FIG. 5 depicts the rods being placed in the slots for the wooden holders, where the holder has been positioned vertically in the slots using its shorter side;

FIG. 6 depicts the rods being placed at an about 45-degree angle inside the holes located in the end-walls of the cavity.

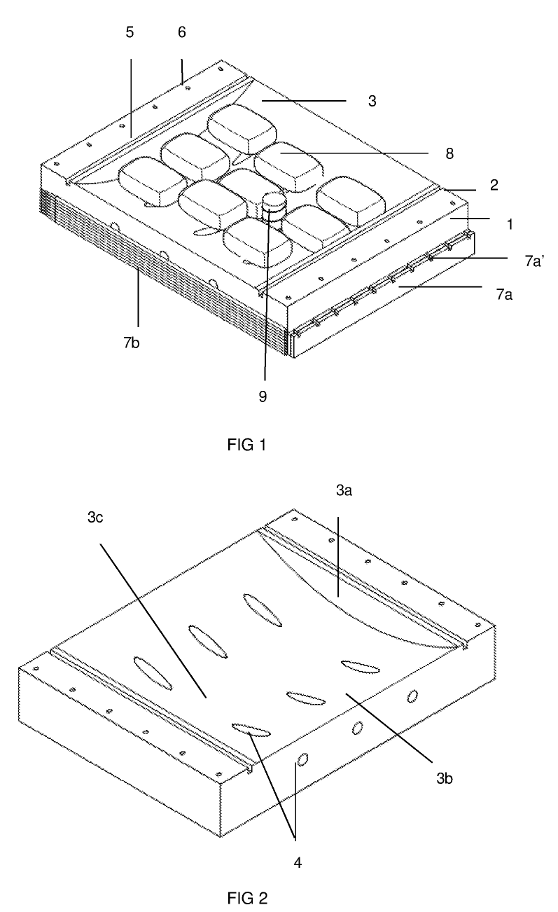

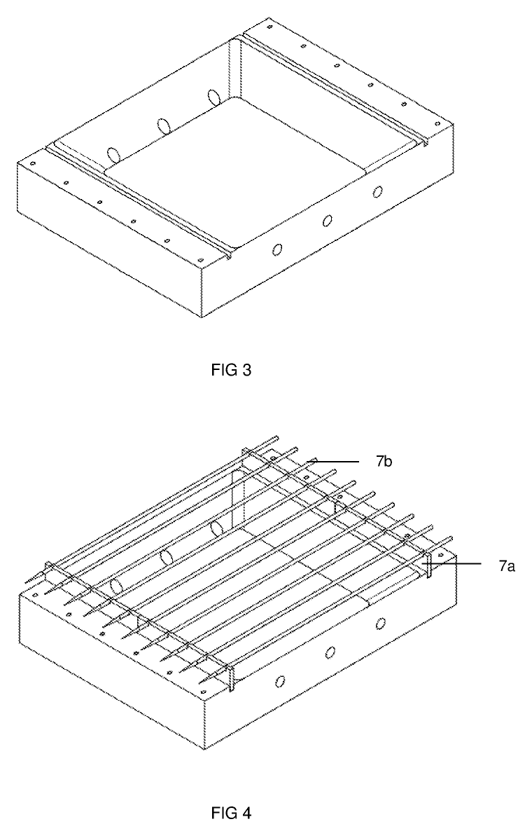

### DESCRIPTION OF AN EMBODIMENT

The described grilling set made of natural materials comprises a wooden frame 1, one surface 2 of which has been significantly carved out to form a cavity 3, thereat leaving the sides of the surface intact from the cavity. The cavity has been provided for the installation of the ignition material 8 and the ignition device 9. The cavity has sidewalls 3a, end-walls 3b and a base 3c. Ventilation slots 4 have been cut in the sidewalls 3a. On the sides of the surface, there are grooves 5 and holes 6 for the holding device 7 of the grilling product. The surface of the wooden frame that is used for grilling is preferably coated with a natural protective agent to protect it from combustion/heat.

Holders 7a and/or rods 7b are used for positioning the food that is to be grilled above the ignition material. The holders are rectangular plates with slots 7a′ made along one or both of its longer sides. The holders shall be inserted into the grooves 5 cut into the sides of the frame. There are dedicated holes 6 on the sides of the frame for the mounting of the rods, or the rods shall be mounted in the slots 7a′ on the holders.

The frame can be manufactured from a single beam and several laminboards using wood adhesives. The height of the wooden frame is between 3 cm to 10 cm, depending on the thickness of the beam. The length of the frame is between 150 mm to 500 mm, width being between 160 mm to 420 mm. Several variations are possible—ranging from small (200×200 mm) to large (440×500 mm).

Inside one surface 2 of the frame 1, a significant cavity 3 has been cut in such a manner that 10 to 50 mm on both longer sides of the frame 1 remain untouched from the cavity. The base 3c of the cavity 3 may have a concaving base or a rectangular flat base. The thickness of the base of the frame 1 remains between 5 to 70 mm.

Ventilation slots 4 are located on the sidewalls 3b and/or end-walls 3a of the cavity 3 with a diameter of 5 mm to 20 mm into the cavity; the distance between the ventilation slots is 20 to 100 mm, which ensures a uniform combustion and temperature of the ignition material.

There are holes on the sides of the frame for grilling rods spaced 10-100 mm apart with a diameter of up to 12 mm, a depth between 10-50 mm, and an angle remaining between 30 to 60 degrees.

The radius of the round cavity is between 90-260 mm. In case of a larger product, also the radius increases.

The sidewalls and end-walls of a rectangular base are tilted inward at a 35-45-degree angle. The corners of the cavity have a round radius between 10-30 mm.

To protect the surface used for grilling from combustion/heat, it is covered with a natural protective agent, preferably clay or salt water. An advantage of clay is also that it conducts heat upward, and that it provides more uniform heat for the food to be grilled during the combustion of the ignition material.

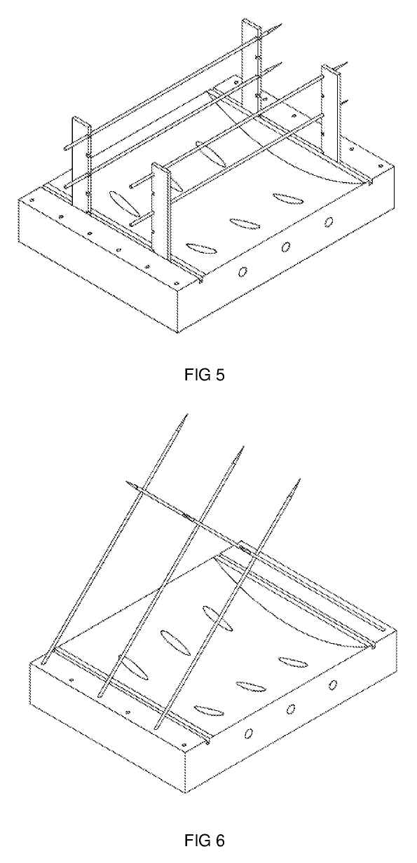

Wooden rods can be used in various ways during grilling, thereby providing more or less heat to the grilling product:
the rods can be mounted into the slots on the wooden holders transversely to the holder, where the holder's longer edge has been mounted horizontally into the grooves, when the food requires more heat (FIG. 4);
the rods can be mounted into the slots on the wooden holders transversely and in parallel to the holder, where the holder's longer edge has been mounted horizontally into the grooves, thereby forming a grate from the rods;
the rods can be mounted into the slots on the wooden holders, where the holder has been mounted into the grooves vertically to the shorter edge, when the food requires less heat (FIG. 5);
the rods can be mounted at an about 45-degree angle into the holes on the sides of the frame, where the food requires less heat (FIG. 6);
several holders with slots on both longer sides can be used for mounting the holders vertically into the grooves and mounting rods into their slots at different heights and using a different level of density; also, when the rods are mounted in a crossed pattern, they form a grate.

Also, other rod mounting options are possible (e.g. horizontally and vertically, thereby forming a grate).

The ignition material 8 is a charcoal briquette or thermal-treated wooden chips burning at a low temperature. The charcoal briquette is made of compressed charcoal that does not burn with a flame and that ensures a uniform combustion between 450-550° C. for at least an hour to cook food in a uniform manner.

The ignition device 9 is an ignition tablet, which has been manufactured from a combustible natural material. Also, the grilling set may comprise matches for igniting the ignition material. At the same time, the ignition device can be ignited using other available means.

The grilling set is of natural material and it burns completely up during its use. The burn-up time of the grilling set can be postponed by covering the whole grilling set or only the surface (and the concave) used for grilling using a natural protective agent.

1. (canceled)

2. The grilling set made of natural materials according to claim 17, wherein a part of the base of the cavity is concave.

3. The grilling set made of natural materials according to claim 17, wherein a part of the base of the cavity is flat.

4. The grilling set made of natural materials in according to claim 17, wherein the cavity and/or the surface of the wooden frame have been coated with a natural protective agent.

5. The grilling set made of natural materials according to claim 4, wherein the natural protective agent is clay.

6. The grilling set made of natural materials according to claim 4, wherein the natural protective agent is saltwater.

7. The grilling set made of natural materials according to claim 17, wherein the ignition material is a charcoal briquette.

8. The grilling set made of natural materials according to claim 17, wherein the ignition material is thermal-treated wooden chips.

9. The grilling set made of natural materials according to claim 17, wherein the wooden holders are rectangular plates with two longer sides and two shorter sides, with slots along at least one of its longer sides.

10. The grilling set made of natural materials according to claim 17, wherein the set includes at least two wooden holders configured to be mounted into the grooves on the surface of the wooden frame during us.

11. The grilling set made of natural materials according to claim 10, wherein the wooden holders are mounted horizontally into the grooves during us.

12. The grilling set made of natural materials according to claim 10, wherein the wooden holders are mounted vertically into the grooves during us.

13. The grilling set made of natural materials according to claim 17, wherein the wooden rods are mounted at an about 45-degree angle into the holes on the sides of the surface of the wooden frame during us.

14. The grilling set made of natural materials according to claim 17, wherein the wooden rods are mounted horizontally into the slots on the wooden holders mounted into the grooves.

15. The grilling set made of natural materials according to claim 17, wherein the wooden rods are mounted vertically into the slots on the wooden holders mounted into the grooves.

16. (canceled)

17. A grilling set made of natural materials comprising:
a wooden frame having a surface partially formed by a cut cavity and partially by uncut portions, wherein the uncut portions have grooves and holes;
said cavity having a base, sidewalls, and end-walls, said cavity having ventilation holes on the sidewalls and/or the end-walls; and
an ignition material and ignition device, wherein said ignition material is a material burning at a low temperature; and
a holding device configured to hold a grilling product above the ignition material, wherein said holding device consists of wooden rods, or wooden rods and wooden holders.

18. The grilling set made of natural materials according to claim 17, wherein the grooves and holes are configured to support the holding device such that the holes support the wooden rods and the grooves support the wooden holders.
